(19) United States
(12) Patent Application Publication
(10) Pub. No.: US 2009/0222440 A1
(43) Pub. Date: Sep. 3, 2009

(54) SEARCH ENGINE FOR CARRYING OUT A LOCATION-DEPENDENT SEARCH

(75) Inventors: Reimar Hantke, Herrsching (DE); Florian Lohmeier, Muenchen (DE)

Correspondence Address: DARBY & DARBY P.C., P.O. BOX 770, Church Street Station, New York, NY, 10008-0770, US

(73) Assignee: t-info GmbH, Munich (DE)

(21) Appl. No.: 12/089,871

(22) PCT Filed: Oct. 9, 2006
(86) PCT No.: PCT/EP2006/009741

§ 371 Date: Jul. 16, 2008

(30) Foreign Application Priority Data
Oct. 10, 2005 (EP) 05109402.7

(51) Int. Cl. G06F 17/30

(52) U.S. Cl. 707/5; 707/10; 707/E17.018; 707/E17.017; 707/E17.108; 707/100

(57) ABSTRACT

The invention relates to a search engine for carrying out a search for internet pages, for which a geographic origin criterion input by the user as a search item is fulfilled. The search engine comprises: a device for carrying out a multitude of internet pages; a device for extracting geographic data from the searched pages, the extracted data describing the geographic origin of the page or of the page provider; a device for forming a database in which geographic data extracted from these internet pages are assigned to a multitude of searched internet pages; an input interface for inputting a search inquiry by the user, the input interface enabling the user to input a geographic origin criterion in addition to other search items; searching the database and outputting those internet pages for which the geographic origin criterion and the additional search items are fulfilled by comparing with the contents of the internet pages and with the geographic data assigned thereto.

### CROSS-REFERENCE TO PRIOR APPLICATION

This is a U.S. National Phase application under 35 U.S.C. §371 of International Application No. PCT/EP2006/009741, filed Oct. 9, 2006 and claims benefit of European Patent Application No. 05109402.7, filed Oct. 10, 2005, both of which are incorporated herein. The International Application was published in German on Apr. 19, 2007 as WO 2007/042245 A1 under PCT Article 21(2).

### FIELD OF THE INVENTION

The present invention relates to a search engine for a location-specific search.

### BACKGROUND OF THE INVENTION

Search engines are specific computers or programmed data processing equipment for searching for web pages which meet specific search criteria input by a user. To perform the task, a search engine loads the internet pages on to the computer of the search engine, indexes the searched pages and furthermore provides a user interface and an enquiry unit to filter the indexed pages in consideration of search criteria input by the user and to display to the user the pages, so-called hits, which have then been found.

For downloading, a search engine typically contains a so-called crawler which automatically contacts internet addresses and downloads the contents of the respective web sites for further processing (indexing).

In contrast to databases, which have been known for a long time, the contents of web sites are however usually unstructured items of information and the semantic content of the individual terms of a web site can only be identified with difficulty. This greatly restricts the indexing possibilities and thus the search possibilities. Thus, a web page indexing performed by a search engine is de facto always a full-text indexing, in other words, from all the terms which appear on the web site (apart from predefined meaningless stop words) a full-text index is formed, against which the search query is then “matched”.

In conventional search engine technology, a user inputs search terms into an input interface, on the basis of which a search query is then sent to a database of the search engine, an application of the search terms to the database or the index then optionally produces “matches” or “hits”, and the corresponding pages or links are displayed to the user.

A problem of conventional search engines is that it is difficult to restrict the hits which have been established to a specific geographic search criterion. Although the user can input a location, for example “Berlin”, as the search term, it does not mean that only those pages will be found which contain the desired geographic reference. Instead, on account of the full-text indexing which does not differentiate according to semantic content, pages are also found in which the word “Berlin” appears not as the geographic point of origin of the presented web page, but in another sense. Thus, for example, when inputting a search with the search terms “car dealership” and “Berlin”, it is also possible for a page to appear as a hit in which somebody reports on his trip to Berlin and, during the trip, the car was damaged and he had to look for a car dealership. However, hits of this type are undesirable in a location-based search containing “Berlin” as the geographic origin criterion.

It is therefore an object of the present invention to provide a search engine which produces as hits those internet pages for which a desired geographic origin criterion is satisfied.

### SUMMARY OF THE INVENTION

According to an embodiment of the invention, the invention comprises a search engine for carrying out a search for internet pages for which a geographic origin criterion input by the user as a search term is satisfied, the search engine comprising:

a unit for searching a plurality of internet pages;

a unit for extracting geographic data from the searched pages, the extracted data respectively designating the geographic reference or the geographic assignation of the page or the page provider;

a unit for creating datasets in which geographic data extracted from a plurality of searched internet pages is assigned to these internet pages;

an interface for allowing the user to input a geographic origin criterion in addition to other search terms;

searching the datasets and outputting those internet pages for which the geographic origin criterion and the further search terms match by comparing with the contents of the internet pages and the geographic data respectively assigned thereto.

The extraction of geographic origin information as well as the assignation thereof to individual pages allows a database of internet pages to be produced which can be searched in a targeted manner for geographic origin criteria.

According to an embodiment, the unit for extracting the geographic origin information comprises:

a unit for applying a set of rules to the content of an internet page to extract that information which could specify an address or a geographic origin corresponding to the criteria of the set of rules;

a unit for verifying the possible geographic origin information by comparing with a database of existent addresses and/or parts of addresses.

The application of a set of rules to contents of individual internet pages allows a check to be made to find out whether individual constituents meet predetermined conditions and thus are considered as candidates for geographic origin information, for example addresses, and provides corresponding candidates. Checking or comparing candidates of this type with a database of existing address data or parts of addresses allows a further increase in the probability that the candidates extracted according to the set of rules are actually items of address data. If appropriate, candidates which “fail” this test can be rejected, so that in fact only valid addresses or geographic origin data remain.

According to an embodiment, the search engine further comprises a unit for assessing whether the searched page is the page of a commercial provider.

The check to ascertain whether it is the page of a commercial provider makes it possible for only commercial pages to be included in the database and thus to be output as results.

According to an embodiment, the search engine further comprises a unit for geocoding the searched internet page in that a geocoding is determined by a geographic coordinate system and is assigned to the internet page based on the extracted geographic origin information, by comparing extracted address information or geographic information with a database of existing geo-information data.

The assignation of geocoding data to the web pages based on the extracted geographic information makes it possible to limit the search to precisely those search conditions which are defined by geographic coordinates and to output relevant hits. This includes, in addition to exact local information, in particular also the searching of the surrounding area or also the use of an interface in the form of a map on which the search area is then defined.

According to an embodiment, the search engine further comprises a unit for searching the individual internet pages for a plurality of terms which are suitable for classifying said internet pages by the provided content and, in the event of a hit, optionally while applying further conditions, a corresponding classification is assigned to the internet page.

Searching for classification terms from a predefined database of such terms makes it possible to assign classification terms of this type to the individual web pages. This can then be used, for example for a further specification of the search query, for example to present as hits only those web pages which have been allocated a classification term input by the user.

According to an embodiment, the search engine further comprises a unit for indexing the searched pages which have been allocated geographic origin information and optionally further classification information; a unit for comparing the search terms with the content of the formed index; and an output of the hits obtained, wherein the geographic origin information allocated to an internet page serves as a filter criterion for the output of the hit list, via comparing with the geographic origin information input as the search term.

The indexing of the database of web pages or internet addresses which have been allocated geographic origin information and possibly also further information, such as geocoordinates and/or classification information, allows comparing with a search query which contains, inter alia, a geographic search criterion, and also allows the output of the relevant hits to the user.

According to an embodiment, the search engine further comprises a unit for normalising the extracted geographic information to put this information into a standardised format, which then outputs to the user, as a “business card”, the address information and optionally further contact information together with the internet address.

Normalisation can take place in that information which can be in various forms but can have the same semantic content is replaced by or converted into a standard term or a standard format, so that for example an address or a telephone number is always output to the user in the same format. By virtue of the output together with the URL of the hit, the user can immediately recognise information which is particularly important to him, such as address information or a telephone number and it may then be quite unnecessary for him to click on the link of the hit and look at the corresponding page.

According to an embodiment, the search engine further comprises a database of internet addresses which are to be downloaded by the crawler and searched by the extraction unit, a unit for dynamically adapting the database by adding new links established by the extraction unit when searching the downloaded pages; and/or rejecting internet addresses for which the extraction unit has established that the predetermined criteria for the extraction of geographic information have not been met; and also as a unit for the repeated downloading and searching of the internet addresses of the database.

The dynamic adaptation of the database makes it possible to add new contents into the web page database which is to be searched, and to remove irrelevant pages from said database if these pages do not comply with a predefined relevance criterion (for example, only pages of commercial providers are relevant).

According to an embodiment, the search engine comprises a unit for identifying additional information which is to be displayed and which is displayed in addition to the hits displayed in response to a search query, this unit comprising a unit for identifying topics on which additional information is to be displayed.

The display of additional information can be useful to the user if this additional information has a topical connection with the hits. It can also be useful to the search engine operator, for example for inserting topically relevant advertising.

According to an embodiment, a unit for identifying the topic comprises a unit for counting the frequency of individual words which appear in the hit or hits to identify, based on the most frequently appearing words, the topic on which additional information is to be displayed; and/or a unit for looking up topics assigned to the respective hits, in order to identify on this basis the topic or topics on which additional information is to be displayed.

Counting the words in the hits, with a separate count being made for every different word, is an efficient method for identifying the topic if a lexicon is accessed in which the words are each assigned to topics.

According to an embodiment, the displayed additional items of information are advertising links and the order in which the advertising links are displayed is based on how often users have already clicked on a web link. This makes it possible for the search engine operator to efficiently put up and invoice for advertisements.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description

### BRIEF DESCRIPTION OF THE DRAWINGS

FIG. 1 schematically shows a construction of a search engine according to a first embodiment of the invention.

FIG. 2 shows a flow chart illustrating the operation of a search engine according to an embodiment of the invention.

FIG. 3 shows a flow chart illustrating the operation of a search engine according to a further embodiment of the invention.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

The present invention will be described in detail in the following using a plurality of embodiments.

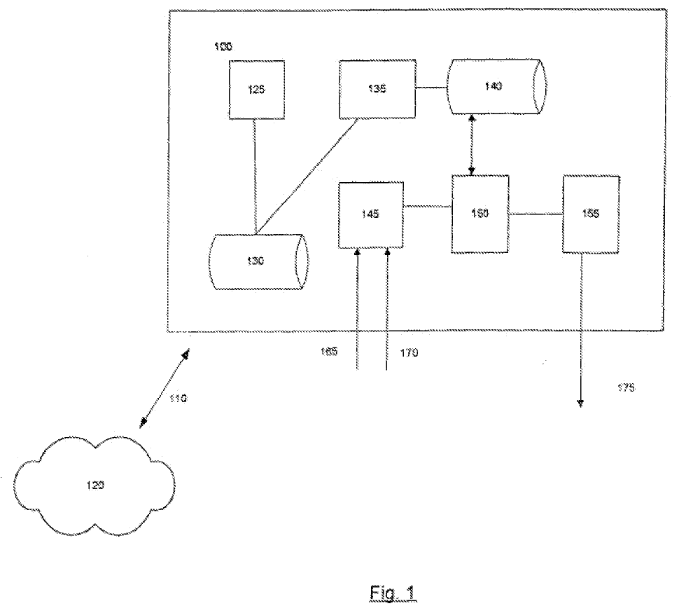

FIG. 1 schematically shows a configuration according to a first embodiment of the present invention.

FIG. 1 schematically shows a search engine according to a first embodiment. The search engine is implemented by a computer 100. The computer has a connection 110 to the internet 120. By means of a unit for searching the internet, a so-called crawler 125, the computer 100 is capable of systematically downloading various pages of the internet and searching the contents thereof. The crawler 125 stores the contents in a memory 130. An extraction unit 135 searches the downloaded pages to ascertain whether they contain any geographic origin information which indicates the geographic origin of the page provider or of the searched web page. If this is the case, the corresponding geographic information is extracted and then assigned to the relevant page. Those pages for which such an assignment was successful are then saved in a database 140.

An interface 145 allows the visitor to input one or more search terms 165 and to separately input a geographic origin criterion 170 as search terms. The search terms can be, for example topical terms (for example “shoes”, “pizza”, “restaurant”, etc). The geographic origin information can be, for example a place name, a district, a road name etc, or, if supported by the input interface and the search engine, as described later on, also location coordinates or a location or surrounding area established by a map. This search query is then processed by the search unit 150 in that it searches for the internet pages in the database 140 which are relevant to the search terms. The corresponding internet pages are then output by the output interface 150 and displayed to the user. In the process, the unit 150 for searching the database uses the geographic origin information, which was input as a further geographic search criterion 170 in addition to one or more random search terms, to filter those web pages out of the database 140 which are relevant to the geographic origin criterion. According to an embodiment, this can be carried out by applying the random search terms 165 to the database by means of a conventional search engine technology to find a first set of corresponding hits, then only those web pages which are relevant to the geographic origin criterion are filtered from this first set of hits, while checking the geographic information assigned to the hits, and a second set of hits 175 which is ultimately the search result is output.

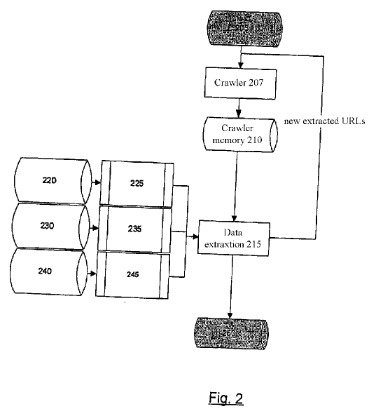

The invention will be described in more precise detail in the following according to a further embodiment. FIG. 2 thus shows a flow chart which illustrates the operation of a search engine according to an embodiment of the invention.

The “crawler” searches a plurality of pages of the internet in a step 200. This can take place, for example, in that the crawler is provided with a predefined number of internet pages, for example in the form of a database 205 which is then downloaded by the crawler and is saved in a crawler memory 210. The pages saved in the crawler memory are then analysed by an extraction process 215 and in particular geographic origin information, for example in the form of addresses, is extracted from the data saved in the crawler memory and assigned to the respective pages. According to the present embodiment, a multistage method is used in this process for extracting the data.

Address data is extracted from the page contents saved in the crawler memory 210 by means of comparing with an address database 220 as well as by applying a set of rules 225. This can take place, for example, in that a predefined database containing addresses (for example the data of a telephone book, a yellow pages or another list of addresses) is compared as address database 220 with the data of the web page and if it matches, the corresponding address data is extracted. For this purpose, it is possible not only to search for one-to-one matches, but rather also to follow a heuristic approach using a set of rules. Thus, for example, according to the set of rules, when the word “address” is found in the page content and furthermore a number which is in a post code directory is found in the following lines, it can be assumed that this is an address. Similarly, for example, it is possible to search for the abbreviation “Tel.” or “Tel.No.”, and on finding such an abbreviation, it can be assumed that the following numbers contain a telephone number. To check further in this respect, it is possible to match some of the telephone numbers which have been found, for example against a dialling code directory, according to the set of rules. The addresses can be assessed by identifying, from a plurality of addresses contained on the web page, the one which characterises the headquarters of a business, or identifies its subsidiaries or branches. This is carried out by assessing the semantic environment with the source of the addresses and via a comparison of the frequency of the place of appearance of specific types of address. Moreover, it is consequently also possible to identify addresses which do not belong to the company itself, but belong for example to service providers or customers.

Similarly, it is possible to search for names of places and towns by means of the set of rules, in which case if these names are preceded by a post code which can be checked by matching against the database 220, this should fairly certainly be part of an item of address information. The use of a database 220 in conjunction with a corresponding set of rules 225 then makes it possible to extract address information from the web page data saved in the crawler memory.

In this case, the set of rules may also contain a check to ascertain whether the searched page is a page of a “commercial provider” or a non-commercial page. Pointers to the presence of a commercial page would be, for example, bank details or reference to the legal form of a company (for example, GmbH, AG, GmbH & Co., etc.). Using sets of rules of this type, it is then possible for a decision to be made as to whether the searched page is a commercial page or a non-commercial page. If only commercial pages are to be included in the database, the presence of a non-commercial page can result in this page being rejected.

In addition to the extraction of address data, the set of rules can also be adapted in such a way that further relevant data, for example opening times, can be extracted from a web page. This, too, can take place in that a search is made for predefined terms (for example “open”, or “opening times” or “business hours”) and the following terms are then subjected to a plausibility check or format check to ascertain whether these are opening times. This can be carried out by matching against predefined patterns (templates) which are representative of possible opening time presentations. Thus, for example, templates for the days of the week (Mon, Tues, Wed, Thur, etc.) or templates for times of day (two digit number, then colon or full stop, then another two digit number) can be filed. By matching against patterns or “templates” of this type, it is possible to ascertain whether the extracted data relates to opening times.

In a further step, the pages of the crawler memory are “geocoded”. Geocoding here means the allocation to the web page of geographic data, for example data in the form of a degree of longitude and degree of latitude or another comparable coordinate system (X, Y). For this purpose, the extracted local information which is already present from the address extraction is accessed by a set of rules 235 which in turn uses a database 230 in which the geographic coordinates of the locations are filed. Thus for example, for a Munich address at 28 Maximilian Road, the geocoding process 235 can then access the database 230 in which the corresponding coordinates X, Y are filed for this location, for example as longitude and latitude information. These coordinates are then assigned to the relevant web page.

According to a further embodiment, the extraction process can further include the extraction of classification data. In this case, classification data means such data as classifies a web page from the crawler memory by the semantic or other content that has been determined. One possibility for a classification of this type would be, for example, a business classification which carries out a classification into different sectors or also makes an allocation to products or brands. Suitable classification terms can for example be the names of sectors (fashion, photography, advertisement, catering, etc.) or other categorisations (for example, the number of stars for a hotel).

To carry out a classification extraction of this type, a database 240 can be provided which, in connection with a set of rules 245, searches the pages saved in the crawler memory to ascertain whether they belong to a specific business category. Thus for example, the database may contain the term “car dealership”; if this term then appears in a page which has been searched, then the classification “car dealership” can be assigned to this page.

In order to avoid incorrect allocations, the set of rules 245 can be constructed to be redundant or complex in such a way that a plurality of criteria has to be met in order to allocate a specific business classification to a web page. Thus for example, different parts of a web page (for example title, body, header, description, Meta tags, etc.) can be searched separately and only if there is a hit in different parts of the web page is a positive decision made that the corresponding classification should be given. Furthermore, a specific threshold value, for example, can also be predetermined which specifies how often at least the searched term must appear for a corresponding classification to be allocated to this web page. This threshold value can be defined separately for individual parts of the web site and additionally for the web site overall, and only when all threshold limits are exceeded is the corresponding classification allocated. It can be stated quite generally that it is possible to search different parts of the web site separately, to weight the respective hits separately (also optionally in terms of number) and finally to combine them into an overall score which then serves as a basis for a decision (for example by checking whether the overall score is greater than a specific threshold value) as to whether the page is given the corresponding classification.

According to an embodiment, a plurality of business classifications can thus be allocated to a web page. The database 240 can be formed, for example, using predefined databases, for example yellow pages or also a compilation of data of a commercial provider which contains various potential classification terms, in order to achieve an appropriately wide coverage with possible business classifications.

If appropriate, the classification can also be divided into hierarchically different levels so that it can be a matter of a complex taxonomy, the individual elements of which can each be allocated to the corresponding web page in the event of a positive assessment (i.e. the relevant classification is present for the set of rules).

As a result of applying the extraction process 215 to the web pages saved in the crawler memory 210, there is produced a database 250 of web pages which is respectively allocated a plurality of items of additional information. An example of an extract from the database 250 is shown below in Table 1.

TABLE 1

| | | | Geo- | Classi- |
|---|---|---|---|---|
| URL | Address | Telephone | data | fication |
| www.auto-meier.de | Hansestrasse 5 | 089-2345 | X, Y | Car |
| | 80331 Munich | | | dealership |

Table 1 shows, in a purely schematic manner, a possible example of a data record such as could result from the extraction process according to the above description. In this case, it should be noted that the address and the telephone number are listed in separate columns merely by way of example, in order optionally also to allow a separate indexing and search here. However, the telephone numbers could also be contained, for example, in the address data itself.

It should also be noted that only one business classification is shown in Table 1, although a plurality of business classifications, for example, could also be provided, for example even business classifications of different hierarchy levels, for example a) car, b) car rental, c) auto trade, d) car repairs, which would then fill fields in different columns of Table 1 from an allocated web page.

The result of the extraction process 215 is then the database 250 of web pages with allocated geographic origin information (e.g. in the form of addresses) as shown by way of example in the first two columns of Table 1, optionally also with likewise allocated geodata and one or more business classifications (according to a predetermined taxonomy).

According to an embodiment, the database 205 which is downloaded by the crawler and analysed by the extraction process, can change dynamically. For this purpose, for example during the extraction process 215, in addition to the search for geographic origin data, it is also possible for a search to be made for links in the web page, a process which is not illustrated graphically in the extraction mechanism 215 in FIG. 2. If a link of this type which refers to a further web page is found, then this link can be added to the database 205 of addresses to be searched, so that this database changes dynamically by including such links which have been found. Similarly, addresses of the database 205 for which no geographic origin could be verified, or for which other criteria required for inclusion in the database (for example the presence of a commercial page) have not been met, can be removed from the database 205 which is to be searched. This dynamic change in the database 205 makes it possible for the resulting database 250 to adapt dynamically to changes in the internet. In this case, it should also be noted that for this purpose, the entire process of searching and extraction should of course be carried out repeatedly.

On the basis of the resulting and optionally dynamically changing database 250, a search based on a search query by a user can then be carried out. This will be described in more precise detail below.

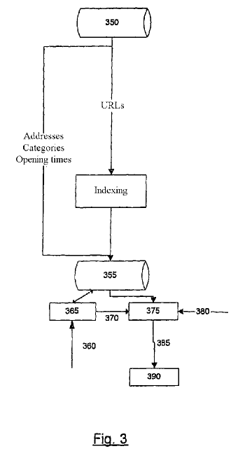

The processing of a search query will now be described in the following with reference to FIG. 3. Starting from the database 350 which is the result of the crawling procedure and the extraction process which was described with reference to FIG. 2, this database is indexed. For this purpose, the information on the page (for example Meta tags, title, headings, pure text, the relationship of links to text), i.e. the number of links to a URL as compared to the unlinked words, as well as the information describing them (for example identifiers within a URL; number, name and sources of the links which refer to this page) is extracted and can be stored in one or more separate indexes. These one or more separate indexes then form the local index 355 shown in FIG. 3. The index 355 can thus be formed in a conventional manner based on the web pages of the database. This means that, for example, a full-text index is formed via the pages of the database 355, the corresponding web site being allocated to every term of the thus formed index. However, in addition to the web site address, the geographic information which belongs to this web site and was extracted in the extraction process is also allocated to a term contained in the index. A portion of a thus formed index can appear as shown below in Table 2.

TABLE 2
Portion of the local index

| Index term | URL | Address |
|---|---|---|
| Room [Zimmer] | www.hotel-maier.de | Karlsplatz 5 |
| | | 80333 Munich |
| Room [Zimmer] | www.hotel-zimmer.de | Sanderstrasse 3 |
| | | 90211 Würzburg |
| Zimmes | www.autohaus-zimmes.de | Rothstrasse 3 |
| | | 80231 Munich |

In addition to a full-text index which indexes the entire content of the web site, as already mentioned, there can be a plurality of further separate (partial) indexes in the local index which are formed only from specific parts of the web site. Thus, there can be separate indexes for Meta tags, titles, headings, for pure text, for the ratio of links to text, i.e. the number of links on a URL as compared to the unlinked words, but also for the information describing them (for example identifiers within a URL; number, name and sources of the links which refer to this page). Each of these (partial) indexes then represents to a certain extent a specific portion of the individual web pages. The various (partial) indexes can then be matched individually against the search query, the individual (partial) queries produce (partial) results and it is then possible to form from these partial results, which each contain zero, one or more web pages as hits, an overall result which will be described in more detail later on.

The local index 355 can therefore consist of one or more (partial) indexes. An embodiment will now be described in the following in which the local index consists of only one (partial) index, for example a full-text index.

If a search query is now applied to the local index 355 using conventional search terms 360, this can take place via a conventional search engine technology, which is shown by way of example as query unit 365 in FIG. 3. The application of the search terms 360 to the index then produces a first set of results (web pages or URLs) 370, which in turn are then refiltered by a refiltering unit 375, namely by using the further search criterion of the geographic origin information 380, which the user input separately and in addition to the standard search terms 360. Only those web pages of the result list 370 for which the refiltering unit 375 establishes, by checking the data structure according to Table 2, that the geographic origin criterion according to search query parameters 380 has been satisfied, then form the final result list 385 which is output to the user. Thus, for example, when the search term “room” is input without a geographic additional criterion, the first two lines of Table 2 are found as the first set of hits. When “Würzburg” is input as a geographic origin criterion, the “hotel Zimmer” is then filtered out of the two hits as the final result, since it is only this web site which also satisfies the geographic origin criterion.

According to an embodiment, the output can be performed by an output interface 390 which displays the results to the user in a form which is preferably ordered according to relevance, for example in a sequence which is the result of a so-called “ranking process”. One possibility for carrying out a ranking process is, for example, the use of the so-called Page-Rank process which is described in U.S. Pat. No. 6,285,999. If a ranking process of this type is not carried out, it is also possible for the results 385 to be presented to the user in an unordered form. Moreover, it is possible for all the results to be output purely according to geographic criteria, for example all the companies (of a specific category) which have their residence in one road.

According to an advantageous embodiment, the links to the web pages identified as hits are displayed together with the extracted address information which is allocated to this link as the result of the extraction process 250. If appropriate, further additional information resulting from the extraction process can also be displayed by the output interface 390, for example the business classification and/or also the geographic data, in the form of coordinates.

An embodiment will now be described in the following in which the local index consists of a plurality of (partial) indexes. Thus, according to this embodiment, a plurality of (partial) indexes is formed for the database 350, namely indexes concerning various categories, it being possible for the categories to be, for example, the additional information resulting from the extraction process, or also indexes formed from different parts of the web sites (as previously described, for example Meta tags, description, etc.). This plurality of indexes can then be used to rank the hits, as will be described more precisely in the following. In this case, categories which can be used for the ranking process may for example be the different sections of a web page, for example the title, the body, the description of the web page, the head, the link information, etc. Thus, it is possible to form for the different parts of the web page various partial indexes and these can then be matched for hits against the search query. Various partial hit lists then result for the various partial indexes, which partial hit lists are then combined together, for example by taking the intersection of all the hits.

The hits in the different partial indexes can then also be used to calculate a “score” representing the relevance, for example in that an individual score is determined for each of the hits in the different partial indexes, based on the number of hits in a specific index (i.e. how often the search term appears in the web site found as a hit or in the part thereof which was used for the index formation), then according to a predefined procedure, these individual scores are weighted differently and then the partial scores of this web page, determined for them in the different matchings against the various partial indexes, are added up. It is thereby possible, according to the respective hits for the different indexes, to make various weightings for the different categories (body, title, description, link, etc.) which then produce, by means of an algorithm for combining the different results, an overall result for a respective page which represents the relevance of this page. Thus, for example a hit in the title of the page can be weighted more heavily than a hit in the body, while a hit in the description part can be assigned an average weighting. The specified factors can be adapted and varied according to the circumstances.

To give a specific example, the local index can consist, for example of a full-text index and an index which was formed only via the “title” part of web sites. The web page www.mamas-pizza.de might then have the word “mama” for example in the title, more specifically only once, but in the entire full-text it might have it 12 times.

The search term is then “mama”, which is matched against the “title” partial index and the “full-text” partial index. The web site www.mamas-pizza.de results as a hit in both cases (presumably in addition to many other web sites), and thus appears as a hit in the hit list of the full-text index as well as in that of the title index. There is then determined for the hit www.mamas-pizza.de in the title index a score which is based, for example, on how often the search term (i.e. “mama”) appears in the title of the web site www.mamas-pizza.de. As this occurs only once, the score for www.mamas-pizza.de for the “title” partial index equals 1. A score is now also determined for the “full-text” partial index, in which www.mamas-pizza.de also appeared as a hit. Since the search term appeared 12 times in the full text, this score is then 12. Both scores are then weighted, it being assumed that the weighting for “title scores” is 3 and the weighting for full text scores is 1. Thus, the overall score for www.mamas-pizza.de is 3×1+1×12=15.

A corresponding score is now also determined for all the other web pages which were found as hits in this search query. On the basis of the thus determined overall scores, the hits can then be output, ordered according to their relevance, which is determined by the overall score.

In the thus described manner, the local index 355 can thus be formed from a plurality of partial indexes which are then combined together to form in effect a “local overall index”.

In a further embodiment, separate indexes can be formed for a contents search (a search for “what”) and a location search (a search for “where”). For this purpose, the georeferenced data is indexed, specifically in such a way that the index is formed via the geometric data, thus such that a search can be made via the input of the geometric data (e.g. via the corresponding coordinates) for web sites allocated to this geometric data. In this case, the geometric data can be input as coordinates or also in another form (for example as place names or addresses, as markings on a map, etc.). If the input is in the form of addresses or takes place via an input map, for example by clicking on the search location or by defining a surrounding area for the surrounding area search, this input is then converted into corresponding coordinates which form the basis for the indexing and can then be matched against the index as a search query.

It is then possible for a “where” search query to be matched against the local coordinate index, and the corresponding results can then be refiltered using the further “what” search criterion, i.e. those hits for which the “what” search criterion then also applies are filtered from the hits, for which the local search query produced a hit. For this purpose the index contains, in addition to the primary key consisting of the local coordinates and the associated web addresses, the corresponding “what” information, thus for example the full text of the corresponding web site. Using this, it is then possible to check whether the “where” criterion as well as the “what” criterion apply.

A more efficient approach when the “what” criterion and the “where” criterion both appear is initially to carry out the “what” search via the local index and to then refilter the hits which have been found by checking whether the “where” search criterion applies to them. This is more efficient than initially searching for the “where” and then refiltering for the “what”, because only one local coordinate, which has to be checked during refiltering, is assigned to each web site, but each web site typically contains a very large amount of “what” information (text etc.), which significantly complicates refiltering for the “what” search criterion compared to refiltering for the “where” search criterion.

In addition a combination of a plurality of indexes is possible so that, for example, georeferenced indexes of, for example, various federal states can be mixed with non-georeferenced indexes, such as a standard search engine index. Consequently, it is possible to mix, for example, local information from non-georeferenced lexicons with the information of a georeferenced index of a town according to the rank value. This then means that the local index consists, for example of georeferenced entries as well as of non-georeferenced entries. A search query then produces, for example, both georeferenced hits and non-georeferenced hits, which are then assessed differently in the ranking process, but are still output in the same results list.

The user can define a search query by inputting a search word (“what”), and alternatively or additionally also by inputting a search area (“where”; for example, place, region, road). This search area can be produced from a name or by means of a freely selectable map portion.

By comparing both terms with the indexed information, the search strategy then produces appropriate results for the user. As already mentioned, this occurs in the event that both a “what” criterion and a “where” criterion were defined, preferably in that initially matching is carried out for the local “what” index, which was formed via the contents of the pages, and subsequently the hits are refiltered by the “where” search criterion. A number of hits are produced which are output to the user.

The search conditions which have to be met for a hit to be output can be defined, for example, as follows:
if a search is made in a location, road or region, then only those results which adequately satisfy this criterion are output
a search can be made in the area surrounding a position (location, centre of location, address, . . . ) at a specific distance (e.g. radius).

According to an embodiment, during a search the user is assisted by support processes which help him to arrive quickly at his desired result. These can comprise, for example:
support in the case of typing errors in that suggestions are produced, the spelling of which is similar to that of the input search word or search location,
support such that while the user is inputting the location, the locations or roads which are consistent with the already input characters are displayed to him,
support in that the user is provided with topically similar searches, in that for example similar search terms based on a lexicon are also displayed.
moreover, the user can be provided with references to topics which appear particularly frequently in the results. For this purpose, for example the words appearing most frequently in the hit pages are determined, meaningless “stop words” (e.g. the, a, etc.) are eliminated and then the most frequent words are compared with a predefined catalogue of topics, to each of which corresponding references are assigned. If there is a match between, for example, the most frequent word and an entry of this type in the catalogue (for example, the word “hotel”), then the information associated with this entry is automatically also output. This can be done, for example, in the form, “For further information on hotels, look under . . . . ” This mechanism can also be used for inserting advertisements. In this case, (typically a plurality of) predefined advertisements are assigned to each of the catalogue entries, thus for example to terms such as car dealership, baker, bookshop, etc. The advertisements (or a specific number thereof, for example 3, 5 or 8) are then displayed with a hit.

In this case, the advertisements which are assigned to a catalogue term and are taken out and paid for, for example, by advertising customers of the search engine operator, can be subjected to a ranking process. In this respect, there are various possibilities for different embodiments. Thus for example, the ranking can be based on how often a user clicks on an advertisement. A score can thus be assigned to every advertisement and a predetermined number of hits, specifically those with the highest score, are then displayed to the user. If the user then clicks on one of the advertisements, its score is then increased.

The score which states how often an advertisement is clicked on can also be used to calculate the costs which the advertising customer has to pay to the search engine operator. In addition to the ranking on the basis of the number of clicks on an advertisement, other factors are also considered which can influence the ranking. Thus for example, a customer who pays more can, in principle, receive a “bonus score”.

The displayed results can be characterised by the following features:
URL which contains the information
display of the address which was assigned to the URL
link to a business card presentation of the company information
link to a card presentation of the location assigned to the URL
the presentation can be made as continuous text or as a table
the presentation of the results can be made as pure text, with a card for orientation, or by means of a card which presents all the results.

The present invention has been described with reference to a plurality of embodiments. The person skilled in the art understands that the invention can be realised and implemented in that a computer is programmed using a conventional programming language such that it is capable of performing the functions of the described embodiments. Accordingly, the search engine according to embodiments of the invention is a programmed computer or also a computer program which enables a computer to operate with its configuration according to the functions of the described embodiments. A method for implementing a described search engine function can also be an embodiment of the invention.

According to a further embodiment, the user can input the geographic origin information not only, for example, by inputting a location, but also by inputting an area, for example by selection on a map. For this purpose, reference is again made to the geocoded data which is already in the database 230, so that it is possible here to determine, by mapping between the geographic data and the corresponding local names, to which geographic area the search query relates.

According to a further embodiment, it is possible to display further additional information for the hits which have been found, in addition to the contents of the hits themselves. In addition, the associated additional company information, for example founding year, products and also e-mail address, value-added tax ID or also the name of the managing director, can be displayed, for example, in a specifically arranged view. This information is also extracted via a specific set of rules, analogously to the procedural method for the extraction of the local information.

An embodiment will be described in the following in which it is determined which information is to be displayed in addition to a hit. In this case, it is determined for a page found as a hit which terms appear most frequently on this page. A check is then made as to whether these terms are consistent with a term of the taxonomy saved in the database 240 of FIG. 2. If this is the case, then it can be assumed that this term has a certain relevance for the search query and thus also for the user. The relevant term can then be shown for the user on the results page itself or assigned separately to the results page, more specifically in such a form that following a click on this term, either a renewed search query takes place on the database which contains this taxonomy term as a search criterion, or a predefined number of predefined links which come under this taxonomy term are displayed to the user. In this case, these links can also be advertising displays which the search engine operator, as the advertiser, shows directly and which refer to companies which pay the search engine operator for these advertising displays. The advertising links are predefined and according to one embodiment are subject to a ranking process, said ranking process being based on how often a user clicks on an advertising link. For this purpose, for each advertising link a counter is operated which counts the number of clicks on this link. This counter can then also be used to draw up an account of the costs which the search engine operator charges the customer who commissioned the advertisement.

As an alternative to counting the words in a hit on the topic which is relevant to this hit and concerning which additional information is to be displayed, it is also possible for a topic to be assigned to each entry in the index, to which topic in turn advertising links are assigned. These advertising links are then displayed (all or the highest ranked links) when the corresponding entry of the index is output as a hit on the search query.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. Search engine for performing a search for internet pages corresponding to a geographic origin criterion input by the user as a search term, wherein the search engine comprises:
a unit for searching a plurality of internet pages;
a unit for extracting geographic data from the searched pages, the extracted data designating the geographic assignation of the page or of the page provider;
a unit for creating datasets in which geographic data extracted from a number of searched internet pages is assigned to these internet pages;
an interface for allowing the user to input a geographic origin criterion in addition to further search terms; and
a unit for searching the datasets and outputting those internet pages for which the geographic origin criterion and the further search terms match by comparing with the contents of the internet pages and the geographic data respectively allocated thereto.

2. Search engine according to claim 1, wherein the unit for extracting the geographic origin information comprises a unit for applying a set of rules to the content of an internet page to extract that information which could specify an address or a geographic origin corresponding to the criteria of the set of rules; a unit for verifying the possible geographic origin information by comparing with a database of existent addresses and/or parts of addresses.

3. Search engine according to claim 1, which further comprises a unit for assessing whether the searched page is the page of a commercial provider.

4. Search engine according to claim 1, which further comprises a unit for geocoding the searched internet page in that a geocoding is determined by a geographic coordinate system and is assigned to the internet page, based on the extracted geographic origin information, by comparing extracted address information with a database of existing geo-information data.

5. Search engine according to claim 1, which further comprises a unit for searching the individual internet pages for a plurality of terms which are suitable for classifying said internet pages by the provided content, wherein in the event of a hit, optionally while applying further conditions, a corresponding classification is applied to the internet page.

6. Search engine according to claim 1, which further comprises a unit for separately searching various parts of the individual internet pages for the plurality of terms, for determining and weighting the hits in the different parts and for determining an overall score on the basis of the weighted hits, wherein a decision is made based on the overall score as to whether a corresponding classification is given to the respective internet page.

7. Search engine according to claim 1, which further comprises a unit for indexing the searched pages to which geographic origin information and optionally further classification information has been assigned; a unit for comparing the search terms with the content of the formed index; an output of the hits obtained, wherein the geographic origin information assigned to an internet page serves as a filter criterion for the output of the hit list, via comparing with the geographic origin information input as the search term.

8. Search engine according to claim 1, which further comprises a unit for forming a plurality of partial indexes for different parts of web pages; a unit for matching the search terms against the content of the respective partial indexes in order to find partial hit lists based on the partial indexes; a unit for forming an overall hit list by combining the partial hit lists.

9. Search engine according to claim 8, which further comprises specific respective weighting of hits from the different partial hit lists; and combining the partial hit lists with the different weightings to form an overall hit list based on the combined weighted partial hit lists.

10. Search engine according to claim 8, which further comprises allocating a score to an individual hit of a partial hit list on the basis of an assessment criterion to assess the relevance of the hit; allocating a weighting, specific to the partial hit list, to an individual hit from a partial hit list; determining an overall score for the hit from the partial hit list by adding the weighted scores which were allocated to this hit in the various partial hit lists.

11. Search engine according to claim 1, which further comprises a unit for normalising the extracted geographic information to put this information into a standardised format which then outputs to the user, as a “business card”, the address information and optionally further contact information together with the internet address.

12. Search engine according to claim 1, which further comprises: a database of internet addresses which are to be downloaded by the crawler and searched by the extractionunit; a unit for dynamically adapting the database by: adding new links established by the extraction unit when searching the downloaded pages; and/or rejecting internet addresses for which the extraction unit has established that the predetermined criteria for the extraction of geographic information have not been met; and also a unit for the repeated downloading and searching of the internet addresses of the database.

13. Search engine according to claim 1, which further comprises: a unit for identifying additional information which is to be displayed and which is displayed in addition to the hits displayed in response to a search query, this unit comprising a unit for identifying the topic on which additional information is to be displayed.

14. Search engine according to claim 13, wherein the unit for identifying the topic comprises: a unit for counting the frequency of individual words which appear in the hit or hits to identify, based on the most frequently appearing words, the topic on which additional information is to be displayed; and/or a unit for looking up topics assigned to the respective hits, in order to determine on this basis the topic or topics on which additional information is to be displayed.

15. Search engine according to claim 13, wherein the displayed additional items of information are advertising links and the sequence of the display of the advertising links is based on how often an advertising link has been clicked on.

16. Device for searching internet pages corresponding to a geographic origin criterion, wherein the device comprises:
a search unit for searching a plurality of internet pages;
an extracting unit for extracting address data from the searched internet pages, the extracted address data designating a geographic assignation of the searched internet pages or of a provider of the searched internet pages;
a verifying unit for verifying extracted address data by comparing the extracted address data with existent addresses and/or parts of existent addresses in a database;
a dataset creating unit for creating datasets in which the verified address data is related to the respective searched internet pages;
an interface for allowing the user to input the geographic origin criterion; and
a dataset search unit for searching the created datasets and outputting those internet pages for which the geographic origin criterion match by comparing the geographic origin criterion with the verified address data.

17. Method for searching internet pages corresponding to a geographic origin criterion, the method comprising the steps of:
searching a plurality of internet pages;
extracting address data from the searched internet pages, the extracted address data designating a geographic assignation of the searched internet pages or of a provider of the searched internet pages;
verifying extracted address data by comparing the extracted address data with existent addresses and/or parts of existent addresses in a database;
creating datasets in which the verified address data is related to the respective searched internet pages;
inputting the geographic origin criterion; and
searching the created datasets and outputting those internet pages for which the geographic origin criterion match by comparing the geographic origin criterion with the verified address data.

18. The method according to claim 17, wherein the step of extracting address data further comprises applying a set of rules to the content of an internet page to extract that information which could specify an address or a geographic origin corresponding to the criteria of the set of rules.

19. The method according to claim 17, further comprising the step of assessing whether the searched page is the page of a commercial provider.

20. The method according to claim 17, further comprising the step of geocoding the searched internet page in that a geocoding is determined by a geographic coordinate system and is assigned to the internet page, based on the extracted address data, by comparing extracted address data with a database of existing geo-information data.

21. The method according to claim 17, further comprising the step of searching the individual internet pages for a plurality of terms which are suitable for classifying said internet pages by the provided content, wherein in the event of a hit, optionally while applying further conditions, a corresponding classification is applied to the internet page.

22. The method according to claim 17, further comprising the step of separately searching various parts of the individual internet pages for the plurality of terms, for determining and weighting the hits in the different parts and for determining an overall score on the basis of the weighted hits, wherein a decision is made based on the overall score as to whether a corresponding classification is given to the respective internet page.

23. The method according to claim 17, further comprising the steps of:
indexing the searched pages to which address data and optionally further classification information has been assigned;
comparing the search terms with the content of the formed index;
outputting the hits obtained, wherein the geographic origin information assigned to an internet page serves as a filter criterion for the output of the hit list, via comparing with the geographic origin criterion input as the search term.

24. A computer-readable medium which stores a set of instructions which when executed performs a method for searching internet pages corresponding to a geographic origin criterion, the method comprising the steps of:
searching a plurality of internet pages;
extracting address data from the searched internet pages, the extracted address data designating a geographic assignation of the searched internet pages or of a provider of the searched internet pages;
verifying extracted address data by comparing the extracted address data with existent addresses and/or parts of existent addresses in a database;
creating datasets in which the verified address data is related to the respective searched internet pages;
inputting the geographic origin criterion; and
searching the created datasets and outputting those internet pages for which the geographic origin criterion match by comparing the geographic origin criterion with the verified address data.

25. Crawler for collecting and evaluating internet pages corresponding to a geographic origin criterion, the crawler comprising:
a unit for contacting an internet addresses and downloading contents of internet pages corresponding the contacted internet address;
an extracting unit for extracting geographic data from the downloaded internet pages, the extracted geographic data designating a geographic assignation of the downloaded internet pages or of the page provider of the downloaded internet pages;
a dataset creating unit for creating datasets in which the geographic data extracted from the downloaded internet pages is related to these internet pages;
an interface for allowing the user to input a geographic origin criterion;
a searching unit for searching the datasets for which the geographic origin criterion matches by comparing the geographic origin criterion with the extracted geographic data;
an output unit for outputting the downloaded internet pages related to the geographic origin criterion; and
a verifying unit for verifying the extracted geographic data by matching the extracted geographic data with existent addresses and/or parts of existent addresses comprised in a database.

26. The crawler according to claim 25, wherein the extracting unit is further adapted to apply a set of rules to the content of an internet page to extract that information which could specify an address or a geographic origin corresponding to the criteria of the set of rules.

27. The crawler according to claim 25, further comprising an assessing unit for assessing whether the searched page is the page of a commercial provider.

28. The crawler according to claim 25, further comprising an geocoding unit for geocoding the searched internet page in that a geocoding is determined by a geographic coordinate system and is assigned to the internet page, based on the extracted address data, by comparing extracted address data with a database of existing geo-information data.

29. The crawler according to claim 25, further comprising a further search unit for searching the individual internet pages for a plurality of terms which are suitable for classifying said internet pages by the provided content, wherein in the event of a hit, optionally while applying further conditions, a corresponding classification is applied to the internet page.

30. The crawler according to claim 25, further comprising a unit for separately searching various parts of the individual internet pages for the plurality of terms, for determining and weighting the hits in the different parts and for determining an overall score on the basis of the weighted hits, wherein a decision is made based on the overall score as to whether a corresponding classification is given to the respective internet page.

31. The crawler according to claim 25, further comprising:
an indexing unit for indexing the searched pages to which address data and optionally further classification information has been assigned;
a comparing unit for comparing the search terms with the content of the formed index;
an outputting unit for outputting the hits obtained, wherein the geographic origin information assigned to an internet page serves as a filter criterion for the output of the hit list, via comparing with the geographic origin criterion input as the search term.
